(19) United States
(12) Patent Application Publication
(10) Pub. No.: US 2021/0118584 A1
(43) Pub. Date: Apr. 22, 2021

(54) DEVICE FOR CARRYING OUT INTERVENTIONS ON A NUCLEAR FUEL ASSEMBLY

(71) Applicant: FRAMATOME, COURBEVOIE (FR)

(72) Inventors: Pierre WEGELER, VILLIEU LOYES MOLLON (FR); Mourad OUNISSI, VILLEFRANCHE SUR SAÔNE (FR)

(21) Appl. No.: 17/254,480

(22) PCT Filed: Jun. 26, 2019
(86) PCT No.: PCT/EP2019/067066

§ 371 Date: Dec. 21, 2020

(30) Foreign Application Priority Data
Jun. 26, 2018 (FR) 18 55737

(51) Int. Cl. G21C 19/26; G21C 17/06; B25J 15/04; B25J 15/02; B25J 9/04

(52) U.S. Cl. CPC G21C 19/26; G21C 17/06; B25J 9/046; B25J 15/0253; B25J 15/04

(57) ABSTRACT

An intervention device for carrying out intervention on a nuclear fuel assembly comprises an articulated robotic arm (22) comprising a securing base (26), a terminal member (28) and at least one arm segment (30, 32) connecting the base (26) to the terminal member (28), and an intervention member (24) carried by the terminal member (28). The intervention member (24) is designed to intervene on the nuclear fuel assembly (2).

The present disclosure relates to an intervention device for a nuclear fuel assembly disposed underwater in the pool.

### BACKGROUND

A nuclear fuel assembly for a pressurized water nuclear reactor comprises a bundle of parallel nuclear fuel rods which are kept spaced apart transversely from one another by a support framework comprising in particular a lower nozzle and an upper nozzle spaced apart along a longitudinal axis, guide tubes extending along the longitudinal axis and connecting the lower nozzle and the upper nozzle to each other, and spacer grids fixed to the guide tubes being distributed along said guide tubes.

The nuclear fuel rods extend along the longitudinal axis between the lower nozzle and the upper nozzle through spacer grids that support the nuclear fuel rods longitudinally and keep them transversely apart from each other.

In a known manner, the spacer grids consist of intersecting plates delimiting cells intended to be traversed by the guide tubes and the fuel rods. In general, the spacer grids are provided with a peripheral belt carrying guide vanes projecting on their lower edge and/or on their upper edge and inclined towards the center of the spacer grid.

Each cell of a spacer grid through which a respective nuclear fuel rod passes, is generally provided on internal surfaces of the cell with retaining elements, such as springs and/or dimples, for longitudinally supporting and transversely holding the nuclear fuel rod passing through this cell.

In operation, a cooling fluid flows through the nuclear fuel assembly along the longitudinal axis, passing between the nuclear fuel rods, and through the end pieces and spacer grids.

Each cell of a spacer grid through which a respective nuclear fuel rod passes may further comprise one or more cooling fluid mixing vanes.

During operation of the nuclear reactor or during maintenance operations of the nuclear reactor, debris in the form of small metal parts may be created.

Such debris is entrained by the cooling fluid and may become stuck in the nuclear fuel assemblies, between the nuclear fuel rods, with the risk of damaging these nuclear fuel rods, and in particular of ultimately causing a loss of sealing of a nuclear fuel rod.

FR2633769A1 discloses a device for extracting debris from a nuclear fuel assembly disposed under water, comprising a pole, a clamp mounted at a lower end of the pole and a mechanism for controlling the opening and closing of the clamp remotely.

However, this extraction device is inconvenient to use. Its positioning is imprecise and it does not allow easy access to all the places where debris may become stuck in a nuclear fuel assembly, nor to ensure in all situations that the forces applied to the components of the nuclear fuel assembly do not damage elements of the device or the nuclear fuel assembly and in particular do not damage the retaining elements of a nuclear fuel rod, for example by applying too great a transverse force to said rod.

During the handling operations of nuclear fuel assemblies in the nuclear reactor, the peripheral plates may be locally damaged by colliding with an adjacent element of the handling chain, for example a storage cell exhibiting a geometric discontinuity or a surface defect, or an adjacent fuel assembly . . . , during the longitudinal displacement of the nuclear fuel assembly with respect to this element, rendering the nuclear fuel assembly unsuitable for loading as it stands in the nuclear reactor core.

FR2641118A1 discloses a device for straightening the guide vanes of the spacer grids of a nuclear fuel assembly comprising a pole, an intervention tool comprising a folding means and a means for supporting and moving the intervention tool.

However, this device for straightening the guide vanes is inconvenient. Its positioning is imprecise and it does not offer sufficient degrees of freedom to allow effective intervention in all configurations, nor to ensure in all situations that the forces applied to the components of the nuclear fuel assembly do not damage elements of the device or of the nuclear fuel assembly and in particular do not damage the retaining elements of a nuclear fuel rod, for example by applying too great a transverse force to said rod.

### SUMMARY

One of the objects of the present disclosure is to provide an intervention device for a nuclear fuel assembly which facilitates interventions without introducing any risk of damage to the elements of the fuel assembly or of the device.

To this end, the present disclosure provides an intervention device for a nuclear fuel assembly disposed under water, the intervention device comprising an articulated robotic arm comprising a securing base, an terminal member and at least one segment of the arm connecting the base to the terminal member, and an intervention member carried by the terminal member, the intervention member being designed to intervene on the nuclear fuel assembly.

The robotic arm equipped with an intervention member makes it possible to move the intervention member and to orient the intervention member so as to easily insert it into the nuclear fuel assembly and to intervene on debris stuck in the nuclear fuel assembly, for example between nuclear fuel rods, in a lower nozzle, in an upper nozzle or in a grid of the nuclear fuel assembly or on a component of the nuclear fuel assembly requiring intervention. The robotic arm may be easily controlled remotely, which makes interventions easier.

The intervention device may comprise one or more of the following optional features, taken individually or in any technically feasible combination:
the robotic arm has a segment of an articulated arm on the base and an actuator designed to move the segment of the arm relative to the base;
the robotic arm has at least two articulated arm segments between it and an actuator designed to rotate each arm segment relative to each other;
the robotic arm has exactly two articulated arm segments, one being articulated on the base and the other carrying the terminal member;
the arm segment carrying the terminal member extends along an axis of the arm segment, the intervention member being movable in rotation with respect to this arm segment about an axis of rotation which is substantially coaxial or parallel with the arm segment axis;
the intervention member is designed to seize debris or a component of the nuclear fuel assembly;
the intervention member is designed to deform debris or a component of the nuclear fuel assembly;
the intervention member is designed to cut debris or a component of the nuclear fuel assembly;
the intervention member is a clamp having two jaws movable relative to one another;
the two jaws extend in a direction of extension, the intervention member being movable in rotation relative to the arm segment carrying the terminal member about an axis of rotation substantially parallel to the direction of extension;
the intervention member is designed to suck up debris and comprises a suction cannula connected to a suction and filtration device;
it comprises a support base, the robotic arm being mounted to move in translation with respect to the support base in at least one direction of translation;
it comprises an actuator designed to move the robotic arm in translation relative to the support base in at least one direction of translation;
the support base is designed to fit into the upper part of a receiving cell of a nuclear fuel assembly;
it comprises several interchangeable intervention tools.

### BRIEF SUMMARY OF THE DRAWINGS

The present disclosure and its advantages will be better understood upon reading the description which follows, given solely by way of a non-limiting example and made with reference to the accompanying drawings, in which:

FIG. 1 is an elevation view of a nuclear fuel assembly;

FIG. 2 is a perspective view of an intervention device for a nuclear fuel assembly, in a first configuration;

FIG. 3 is a perspective view of the intervention device, in a second configuration;

FIG. 4 is a perspective view of the intervention device, in a third configuration; and

FIGS. 5 to 8 are perspective views of interchangeable intervention members of the intervention device.

### DETAILED DESCRIPTION

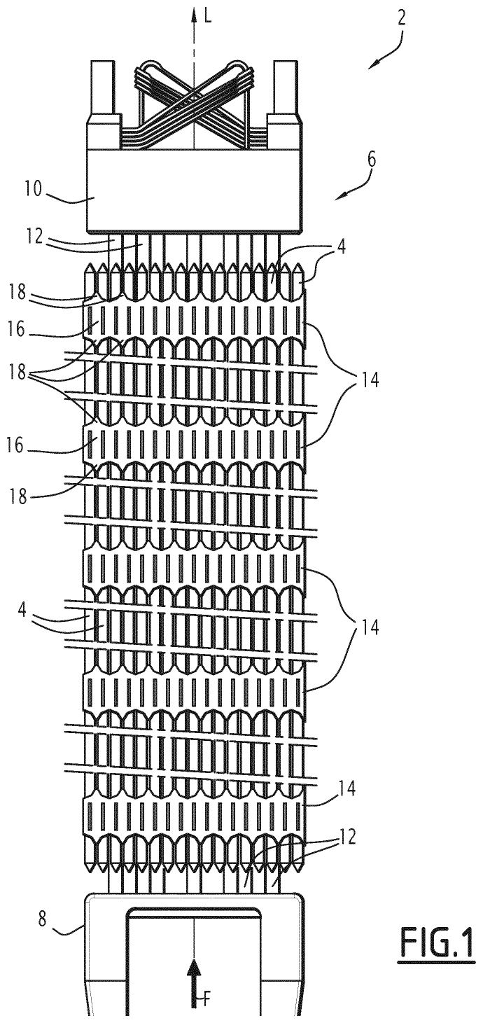

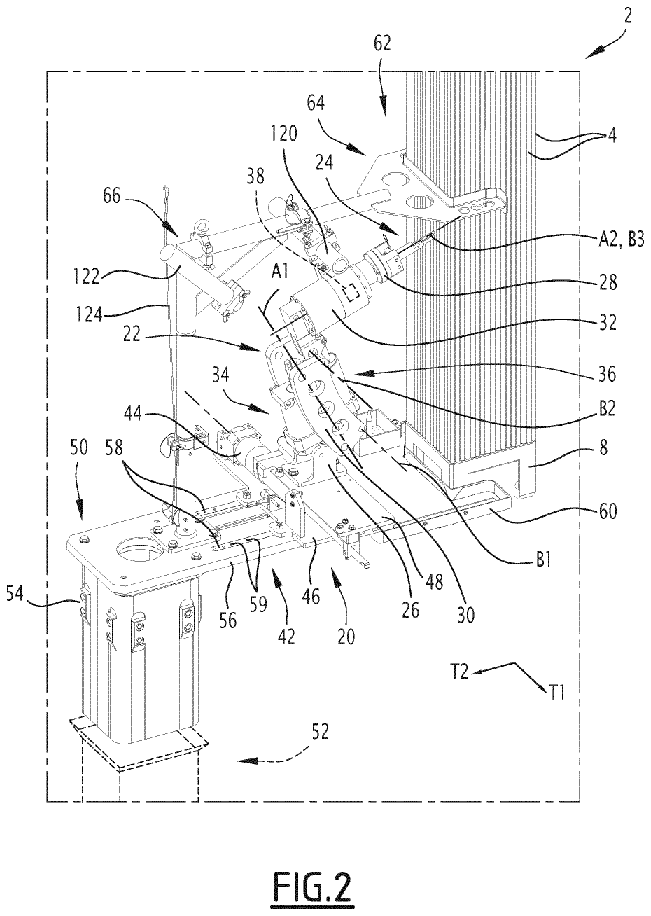

The nuclear fuel assembly 2 of FIGS. 1 and 2 comprises a nuclear fuel rod bundle 4 and a support framework 6 designed to support the nuclear fuel rods 4.

The nuclear fuel rods 4 extend parallel to each other and to a longitudinal axis L of the nuclear fuel assembly 2.

The longitudinal axis L extends vertically when the nuclear fuel assembly 2 is disposed in a nuclear reactor core. In operation, a cooling fluid flows vertically from bottom to top through the nuclear fuel assembly 2, as shown by the arrow F.

In the remainder of the description, the terms “vertical”, “horizontal”, “longitudinal”, “transverse”, “top”, “bottom”, “upper” and “lower” are understood by reference to the nuclear fuel assembly 2 arranged vertically.

The support framework 6 comprises a lower nozzle 8, an upper nozzle 10, a plurality of guide tubes 12 and a plurality of spacer grids 14.

The lower nozzle 8 and the upper nozzle 10 are spaced apart along the longitudinal axis L. The guide tubes 12 extend along the longitudinal axis L and connect the lower nozzle 8 and the upper nozzle 10 between them, by maintaining the distance between the lower nozzle 8 and the upper nozzle 10. The nuclear fuel rods 4 are received between the lower nozzle 8 and the upper nozzle 10.

Each guide tube 12 is open at its upper end to allow the insertion of a control bar inside the guide tube 12, through the upper nozzle 10. Such a control bar allows control of the reactivity of the nuclear reactor core in which the nuclear fuel assembly 2 is inserted.

The spacer grids 14 are distributed along the guide tubes 12, with being spaced apart from each other along the longitudinal axis L. Each spacer grid 14 is rigidly fixed to the guide tubes 12, the guide tubes 12 extending through each spacer grid 14.

Each spacer grid 14 is designed to longitudinally support the nuclear fuel rods 4 while maintaining them in a configuration in which they are spaced apart from each other. The nuclear fuel rods 4 are preferably positioned laterally at the nodes of a substantially regular imaginary network.

Each spacer grid 14 comprises, for example, intersecting inner plates and a peripheral belt, surrounding the inner plates and formed by four peripheral plates 16, thus forming a plurality of cells.

Each cell designed to receive a respective nuclear fuel rod 4 is generally provided with retaining elements coming into contact with the outer surface of the nuclear fuel rod 4 to maintain it longitudinally and transversely.

Each cell for receiving a respective nuclear fuel rod 4 may comprise at least one cooling fluid mixing vane projecting upwards from the spacer grid relative to the longitudinal axis L of the nuclear fuel assembly 2 and being preferably inclined obliquely upwards and inwards to the cell.

The retaining elements of each cell comprise for example at least one elastic spring and/or at least one rigid dimple, each spring being for example designed to push the nuclear fuel rod 4 into abutment against one or more dimples.

Each spacer grid 14 is generally provided with a peripheral belt, formed for example of peripheral plates 16, carrying guide vanes 18 projecting on its lower edge and/or on its upper edge, and inclined towards the center of the spacer grid 14, to guide the spacer grid 14 with the surrounding objects during handling operations of the nuclear fuel assembly 2.

Referring to FIG. 2, the intervention device 20 is designed to intervene on the nuclear fuel assembly 2 under water.

The nuclear fuel assembly 2 is submerged in a body of water, in a pool of the nuclear power plant. For example, the nuclear fuel assembly 2 is suspended in the body of water.

Only the lower part of the nuclear fuel assembly 2 is visible in FIG. 2. The spacer grids 14 have been omitted in FIG. 2 for the sake of clarity of the drawings.

The intervention device 20 comprises an articulated robotic arm 22 and an intervention member 24, in this case a clamp, carried by the robotic arm 22.

The robotic arm 22 comprises a base 26, located at one end of the robotic arm 22 for securing the robotic arm 22 on a support, and a terminal member 28 located at the other end of the robotic arm 22, for securing the intervention member 24 on the robotic arm 22.

The robotic arm 22 has at least one arm segment 30, 32 located between the base 26 and the terminal member 28. Each arm segment 30, 32 is elongated along a respective arm segment axis A1, A2.

The robotic arm 22 comprises for example several arm segments 30, 32 arranged in series between the base 26 and the terminal member 28. The arm segment 30 connected to the base 26 is articulated on the base 26, and each following arm segment 32 is articulated on the preceding arm segment 30, 32.

In an exemplary embodiment, the arm segment axes A1, A2 are coplanar and the arm segments 30, 32 are articulated on the base 26 and between them only about separate and parallel axes of rotation B1, B2, the axes of rotation B1, B2 being substantially perpendicular to the arm segment axes A1, A2.

As a result, the arm segments 30, 32 move in a fixed displacement plane relative to the base 26, the displacement plane being defined by the arm segment axes A1, A2.

In an exemplary embodiment, each arm segment 30, 32 is rotatable relative to the base 26 or to the other arm segment on which it is mounted, through at least 120°, preferably through about 180°.

The robotic arm 22 in this case comprises exactly two arm segments 30, 32, namely a proximal arm segment 30 articulated on the base 26 and a distal arm segment 32 articulated on the proximal arm segment 30 and carrying the terminal member 28.

The proximal arm segment 30 is articulated on the base 26 about a single axis of rotation B1, while the distal arm segment 32 is articulated on the proximal arm segment 30 about a single axis of rotation B2 separate from and parallel to the axis of rotation B1 of the arm segment 30 relative to the base 26.

As an option, the intervention member 24 is mounted to be movable in rotation relative to the arm segment carrying the terminal member 28, in this case the distal arm segment 32, about an axis of rotation B3 coaxial with or parallel to the axis of extension A2 of this arm segment 32.

Preferably, when the arm segments 30, 32 move in a fixed displacement plane relative to the base 26, the axis of rotation of the intervention member 24 relative to the arm segment carrying the terminal member 28 is located in the displacement plane of the arm segments 30, 32.

Once the intervention member 24 is positioned using the robotic arm 22, the rotation of the intervention member 24 about the axis of rotation B3 makes it possible to orient the intervention member 24 to facilitate its insertion into the nuclear fuel assembly 2, for example between the nuclear fuel rods 4 or into the lower nozzle 8 or the upper nozzle 10.

In an exemplary embodiment, the robotic arm 22 is configured such that the intervention member 24 mounted on the robotic arm 22 is movable in rotation about the axis of rotation B3 through 360°. The intervention member 24 is preferably mobile in rotation without angular limitation. The intervention member 24 may make multiple turns in either direction.

The robotic arm 22 has at least one actuator 34, 36, 38 to control the movements of the robotic arm 22 and, optionally, the movements of the intervention member 24. The robotic arm 22 in this case has an actuator 34 to control the orientation of the proximal arm segment 30 relative to the base 26 and an actuator 36 for controlling the orientation of the distal arm segment 32 relative to the proximal arm segment 30.

The robotic arm 22 optionally incorporates an actuator 38 to control the orientation of the intervention member 24 about the axis of rotation B3. The actuator 38 is, for example, integrated in the arm segment carrying the intervention member 24, in this case the distal arm segment 32, which is streamlined.

In the configuration illustrated in FIG. 2, the intervention device 20 comprises a translation assembly 42 on which is mounted the robotic arm 22, the translation assembly 42 being designed to move the robotic arm 22 in translation in a direction of translation T1.

The direction of translation T1 is substantially perpendicular to the plane of movement of the arm segment(s) 30, 32 of the robotic arm 22. The direction of translation T1 is thus substantially parallel to the axis of rotation B1, B2 of each arm segment 30, 32 relative to the base 26 or to the preceding arm segment.

The translation assembly 42 comprises an actuator 44 designed to control the movement of the base 26 in translation in the direction of translation T1. The actuator 44 is in this case a linear jack, for example a hydraulic hack or an electric jack.

The translation assembly 42 comprises a base 46 and a carriage 48 mounted on the base 46 to slide in the direction of translation T1, the actuator 44 being disposed between the base 46 and the carriage 48 to control the movement of the carriage 48 relative to the base 46.

The robotic arm 22 is mounted on the carriage 48 by fixing the base 26 on the carriage 48.

The translation assembly 42 defines a robotic “translation table” for moving the robotic arm 22 in translation.

In the configuration of FIG. 2, the intervention device 20 is configured to be disposed on a cell present in the pool and intended to receive a nuclear fuel assembly 2 under water, for example a storage cell or a lowering basket.

For this purpose, the intervention device 20 comprises a support base 50 designed to fit into the upper part 52 of the cell.

A cell is generally in the form of a tube extending vertically and having a generally square cross-section.

The support base 50 comprises an insertion element 54 designed to fit vertically into the upper part 52 of the cell, and a support element 56 supporting the robotic arm 22 and cantilevered with respect to the insertion element 54.

Once the insertion element 54 is inserted into the upper part 52 of the cell, the intervention device 20 is held in place by its own weight.

Advantageously, the intervention device 20 is placed on the basket of the lowering device in the high position, i.e. when the upper part 52 of the cell is out of the water, to facilitate docking of the intervention device 20 and the insertion of the insertion element 54. The intervention device 20 is then immersed by lowering the lowering device, at the same time submerging any power cables and control of the intervention device 20, until the intervention device 20 is disposed at the desired height relative to the nuclear fuel assembly 2 and with sufficient water height to perform the intervention in complete safety.

During the intervention, the nuclear fuel assembly 2, for example, is suspended in water using a lifting tool.

In the configuration of FIG. 2, the translation assembly 42 is fixed on the support base 50, more precisely on the support member 56, and the robotic arm 22 is fixed on the translation assembly 42.

As an option, the translation assembly 42 may be fixed on the support base 50 so as to be able to adjust the position of the translation assembly 42 in a translation direction T2 perpendicular to the translation direction T1 of the carriage 48, in several adjustment positions, for example discrete adjustment positions.

To do this, the support base 50 is for example provided with at least one rail 58, for example two rails 58, each rail 58 extending in the direction of translation T2 and being provided with several fixing holes 59 distributed around the along rail 58.

Optionally, the intervention device 20 may comprise a receptacle for depositing the debris extracted from the nuclear fuel assembly 2 and for receiving the debris which could fall down during the intervention on the nuclear fuel assembly 2. The receptacle may be provided for example in the form of a plate 60 provided with a rim.

Optionally, the intervention device 20 comprises a guide system 62 designed to position the nuclear fuel assembly 2 and the intervention device 20 relative to each other.

The guide system 62 is advantageously configured to bear on a side face of the nuclear fuel assembly 2 at one or more points spaced apart along the nuclear fuel assembly 2.

Advantageously, in operation, the nuclear fuel assembly 2 is suspended under water, attached to an independent lifting tool. In this configuration, the support force of the guide system 62 on the nuclear fuel assembly 2 is limited. In fact, the nuclear fuel assembly 2 being held in a pendulum manner, it is pushed back by the guide system 62 when the support force of the guide system 62 increases.

The guide system 62 comprises a guide member 64 in the form of a fork with two tines designed to be applied against a side face of the nuclear fuel assembly 2, the nuclear fuel assembly 2 being received between the two tines.

The guide element 64 is carried in this case by a bracket 66 fixed to the support base 50.

The plate 60 is provided for example with a notch formed in an edge of the plate 60 and intended to receive the nuclear fuel assembly 2 to ensure the relative positioning of the intervention device 20 and of the nuclear fuel assembly 2.

Thus, the intervention device 20 rests on the nuclear fuel assembly 2 at two points spaced apart along the nuclear fuel assembly 2.

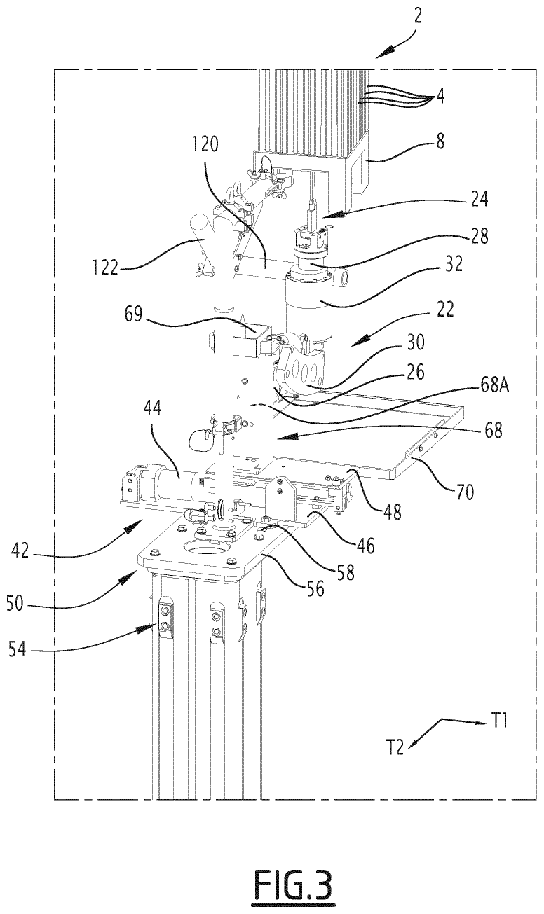

In the configuration of FIG. 3, the intervention device 20 is designed to intervene from below the lower nozzle 8 of the nuclear fuel assembly 2.

The intervention device 20 is provided with an intermediate support 68 having a vertical fixing surface 68A, the base 26 of the robotic arm 22 being fixed on this fixing surface 68A.

This makes it possible to modify the orientation of the robotic arm 22 relative to the nuclear fuel assembly 2 and so facilitate the work of the robotic arm 22. In particular, the robotic arm 22 makes it possible to move the intervention member 24 parallel to the fixing surface 68A, i.e. in this case vertically so as to insert the intervention member 24 into the lower nozzle 8.

The intermediate support 68 is here fixed to the carriage 48 of the translation assembly 42.

As illustrated in FIG. 3, the intervention device 20 comprises a removable receptacle 69 in which the operator deposits the debris or pieces of components extracted or cut by the intervention member 24.

The receptacle 69 is accessible by rotation of the arm segments 30, 32 about the axes of rotation B1, B2.

Furthermore, the plate 60 provided with a notch is replaced by a rectangular or square plate 70, able to extend under the nuclear fuel assembly 2 so as to receive the debris or pieces of components which fall from nuclear fuel assembly 2 during the intervention.

It should be noted that, relative to the configuration of FIG. 2, the translation assembly 42 is offset in the second direction of translation T2 relative to the support base 50.

The device of FIG. 3 allows in particular by a rotational movement of the terminal member 28 to extract debris-type chips or helical springs which have partially passed through the lower nozzle 8.

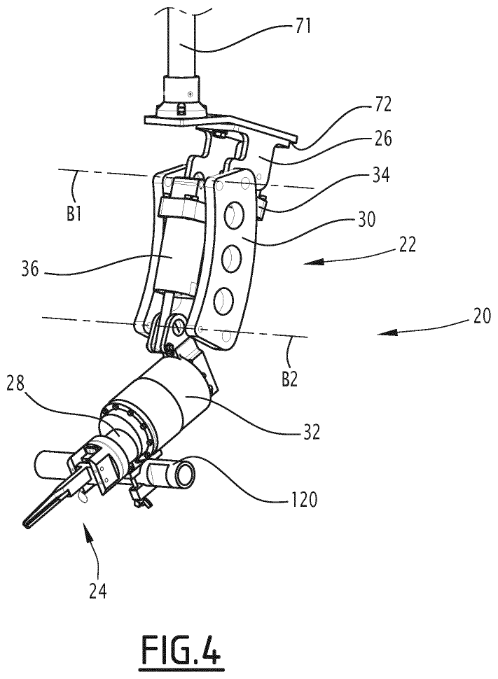

In the configuration of FIG. 4, the intervention device 20 is designed for intervention on the top of the upper nozzle 10 of the nuclear fuel assembly 2.

The robotic arm 22 is mounted at the lower end of a handling pole 71 which may be manipulated from the surface of the body of water in which the procedure is performed.

The base 26 is fixed here on a fixing surface 72 facing downwards. The fixing surface 72 is inclined relative to a horizontal plane at an angle of between −60° and +60° and preferably between −30° and +30°. Such fixing makes it possible to orient the robotic arm 22 so as to intervene in the upper nozzle 10, in particular under the edges of the upper nozzle 10. The shape of the fixing surface 72 and in particular the angle of inclination may be adapted as needed.

The robotic arm 22 is preferably designed to receive several interchangeable intervention members. In particular, the terminal member 28 of the robotic arm 22 is designed for the removable attachment of each intervention member.

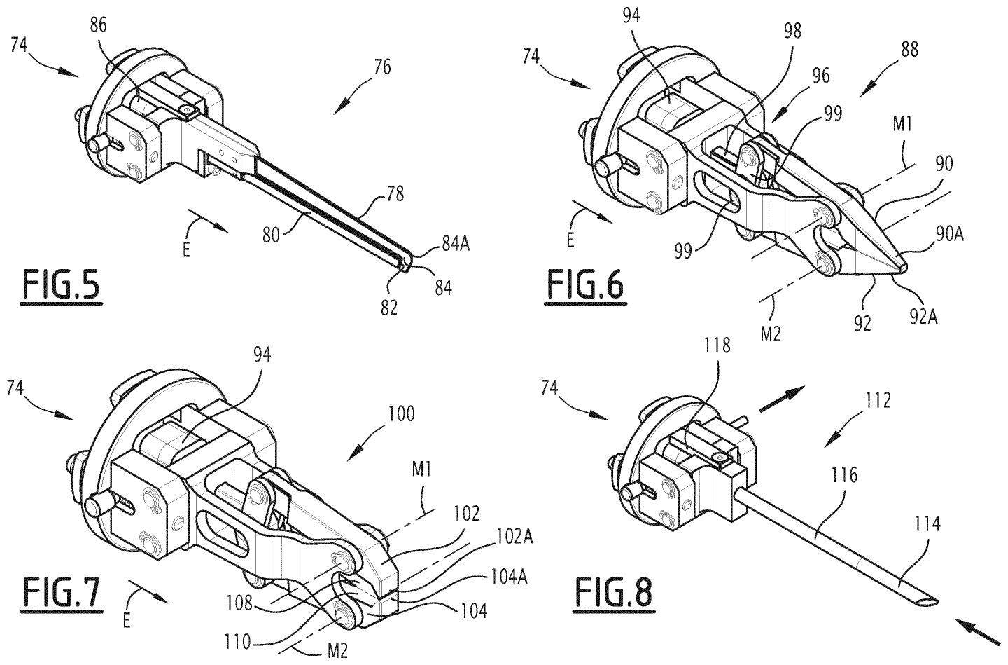

Different intervention members 24 are shown in FIGS. 5 to 8.

Each intervention member 24 is provided with a fixing system 74 for fixing the intervention member on the terminal member 28 of the robotic arm 22. The fixing system 74 is for example of the bayonet type allowing fixing of the intervention member 24 by translation along an axis then rotation about this axis.

In other embodiments, the fixing system of the intervention member 24 may be, for example, a mechanical assembly of the tenon and mortise or dovetail or ball pin type, etc. or a screw connection.

The intervention member shown in FIG. 5 is a clamp 76 designed for gripping debris located between the nuclear fuel rods 4 of the nuclear fuel assembly 2.

The clamp 76 comprises a first jaw 78 and a second jaw 80 in the form of elongated blades in a direction of extension E. The first jaw 78 and the second jaw 80 define between them a clamping space 82.

The first jaw 78 and the second jaw 80 are movable relative to each other so as to vary a dimension of the clamping space 82 to grip or release debris.

The first jaw 78 has a curved end portion 84. The clamping space 82 is defined between the curved end portion 84 and the end of the second jaw 80.

The first jaw 78 and the second jaw 80 are movable relative to each other in the direction of their length (i.e. along the direction of extension E) to vary a dimension of the clamping space 82 to grip or release debris.

In an exemplary embodiment, the first jaw 78 is fixed and the second jaw 80 is movable in translation in the direction of its length (i.e. in the direction of extension E).

The clamp 76 here has a linear actuator 86 arranged to move the first jaw 78 and the second jaw 80 relative to each other, in this case to move the second jaw 80 relative to the first jaw 78.

The curved end portion 84 is provided with a rounded edge 84A which constitutes the most advanced end of the clamp 76. This rounded edge 84A prevents damage to the nuclear fuel rods 4 during the insertion of the clamp 76 between these.

The clamp 76 has low clamping power and is particularly advantageous for removing small debris or debris located in hard-to-reach areas: in the nuclear fuel rod bundle 4, between the nuclear fuel rods 4 and the end pieces 8, 10, in the spacer grids 14 or in hidden areas of the end pieces 8, 10, for example under rims.

The intervention member 24 illustrated in FIG. 6 is also a clamp 88. It differs from that of FIG. 5 in that it has a first jaw 90 and a second jaw 92 in the form of levers and is mounted to rotate around respective axes of rotation M1, M2 parallel to each other so as to separate or bring together the clamping ends 90A, 92A of the first jaw 90 and the second jaw 92.

The first jaw 90 and the second jaw 92 are even shorter, and their clamping ends 90A, 92A are pointed. This clamp 88 makes it possible to extract debris whose extraction requires a greater clamping force or to bend locally, for example a portion of the peripheral plate 16 of a spacer grid 14 of a nuclear fuel assembly 2, in particular a guide vane 18 so that it regains its original geometry.

The clamp 88 has a linear actuator 94 for controlling the opening and closing of the clamp 88, connected to jaws 90, 92 by a transmission mechanism 96 designed to convert the linear motion of actuator 94 to rotational motion of both the first jaw 90 and the second jaw 92.

The transmission mechanism 96 comprises a control rod 98 movable in translation along the direction of extension E and connected to the end of both the first jaw 90 and the second jaw 92 opposite the clamping end of the jaws, by a respective connecting rod 99.

The intervention member 24 illustrated in FIG. 7 is a clamp 100. It differs from that of FIG. 6 by the shape of the first jaw 102 and the second jaw 104 which are designed for cutting. The ends 102A and 104A of the first jaw 102 and the second jaw 104 are in the form of cutting edges. The clamp 100 is a cutting clamp.

Advantageously, the clamp 100 is provided with a clamping device 106 designed to hold the element to be cut before cutting and after cutting, and thus to avoid the dispersion of pieces after cutting.

The clamping device 106 comprises, for example, elastic gaskets 108, 110 arranged on the jaws 102, 104 to clamp the element to be cut together.

The elastic gaskets 108, 110 are for example made of an elastomeric material, for example of the Eladip® type.

This clamp 100 makes it possible to cut and extract debris, the extraction of which in a single piece is not possible given the local configuration. It also makes it possible to locally cut, for example, a portion of a peripheral plate 16 of a spacer grid 14 of a nuclear fuel assembly 2, in particular a guide vane 18 when it is not possible to make it regain its original geometry or a portion of the spacer grid 14 following an overflow as a result of a local tearing during handling.

The intervention member 24 illustrated in FIG. 8 is a suction member 112 having a suction cannula 114 fluidly connected via a suction pipe 116 to a suction and filtration device 118. Debris is retained by the suction and filtration device 118. The water from the pool sucked up with the debris is discharged into the pool at the outlet of the suction and filtration device 118.

In this case, the suction and filtration device 118 is integrated into the suction member 112. As a variant, the suction and filtration device 118 may be offset relative to the suction member 112, and is located for example near the free surface of the pool water. The suction and filtration device 118 is then fluidly connected to the suction member 112 by a pipe.

Like the clamp 76 of FIG. 5, this suction member 112 is able to recover small debris or debris located in areas difficult to access as long as this debris is not firmly stuck in the nuclear fuel assembly. 2.

As illustrated in FIGS. 2 to 4, the intervention device 20 optionally comprises a camera 120 mounted on the robotic arm 22 so as to film the intervention area. The intervention member 24 carried by the robotic arm 22 is located in the axis of the camera 120. The camera 120 is for example fixed to the segment of the arm carrying the terminal member 28, in this case the distal arm segment 32. and covers a transverse field, i.e. along the direction of translation T1.

Advantageously, the intervention device 20 comprises a second camera 122 mounted on the bracket 66 so as to film the intervention area from another angle. As illustrated in FIGS. 2 and 3, the camera 122 covers a field along the longitudinal axis L.

The cameras 120, 122 facilitate the remote control of the intervention device 20 by allowing the operator to better see the intervention area.

Preferably, each actuator 34, 36, 38, 44, 86, 94 is a motor whose power is electronically limited so as to limit the pushing or pulling force that may be applied to the elements of the nuclear fuel assembly 2.

Advantageously, the actuators 86, 94 are designed so that the clamps 76, 88, 100 open in the event of an electrical failure to avoid any risk of the intervention device 20 jamming in the nuclear fuel assembly 2.

A return cable 124 visible in FIG. 2 and not shown in FIG. 3, allows exertion of a return force in the direction of translation T2 to ensure the withdrawal of the intervention member 24 engaged in the assembly of nuclear fuel 2 in the event of an element failure.

In this case, the return cable 124 is arranged to act on the translation assembly 42 (or translation table).

The intervention device of the present disclosure facilitates the operations of extracting debris from a nuclear fuel assembly and the operations of reconfiguring the geometry of the components of the nuclear fuel assembly. The robotic arm may be easily remotely controlled to position and actuate the clamp or suction cannula carried by the robotic arm. The robotic arm has sufficient degrees of freedom for proper positioning of the intervention tool for the required interventions. It is possible if necessary to add arm segments and/or axes of rotation or translation if additional degrees of freedom are required.

The robotic arm allows for easier positioning and control of the intervention tool compared to a tool carried on the end of a pole and operated manually. This limits the risk of damaging the nuclear fuel assembly and in particular the fuel rods and/or the elements holding the nuclear fuel rods in the spacer grids.

The intervention device is easily configurable to perform various interventions, for example the extraction of debris stuck between the nuclear fuel rods, the extraction of debris under or on the lower nozzle, a spacer grid and/or the upper end, the resetting of a spacer grid, for example by folding a guide vane or by cutting out.

The intervention device allows the generation of sufficient clamping power for the removal of heavily stuck debris, and even the use of wire cutters to sever debris, for example to remove it more easily. The wire cutters may also be used to cut a deformed portion of a part that could damage other parts when operating the nuclear reactor or handling the nuclear fuel assembly.

The intervention device may be implemented easily, for example by a single operator controlling the robotic arm remotely.

What is claimed is:

1-15. (canceled)

16. An intervention device for a nuclear fuel assembly arranged under water, the intervention device comprising:
an articulated robotic arm comprising a base for fixing, a terminal member, at least one arm segment connecting the base to the terminal member, and an intervention member carried by the terminal member, the intervention member being configured to act on the nuclear fuel assembly.

17. The intervention device according to claim 16, wherein the at least one arm segment includes an arm segment articulated on the base and an actuator designed to move the arm segment relative to the base.

18. The intervention device according to claim 16, wherein the at least one arm segment includes at least two arm segments articulated between them and an actuator designed to rotate each arm segment relative to each other.

19. The intervention device according to claim 18, wherein the robotic arm has exactly two arm segments articulated together, one being articulated on the base and the other carrying the terminal member.

20. The intervention device according to claim 16, wherein the at least one arm segment includes an arm segment carrying the terminal member and extending along an axis of the arm segment, the intervention member being movable in rotation with respect to this arm segment about an axis of rotation substantially coaxial or parallel with the axis of the arm segment.

21. The intervention device according to claim 16, wherein the intervention member is configured to capture debris or a component of the nuclear fuel assembly.

22. The intervention device according to claim 21, wherein the intervention member is designed to suck up debris and comprises a suction cannula connected to a suction and filtration device.

23. The intervention device according to claim 16, wherein the intervention member is configured to deform a debris or component of the nuclear fuel assembly.

24. The intervention device according to claim 16, wherein the intervention member is configured to cut debris or a component of the nuclear fuel assembly.

25. The intervention device according to claim 16, wherein the intervention member is a clamp having two jaws movable relative to one another.

26. The intervention device according to claim 25, wherein the at least one arm segment includes an arm segment carrying the terminal member, the two jaws extending in an extension direction, the intervention member being movable in rotation relative to the arm segment carrying the terminal member about an axis of rotation substantially parallel to the direction of extension.

27. The intervention device according to claim 16, comprising a support base, the robotic arm being mounted to be movable in translation relative to the support base in at least one direction of translation.

28. The intervention device according to claim 27, further comprising an actuator designed to move the robotic arm in translation relative to the support base in at least one direction of translation.

29. The intervention device according to claim 28, wherein the support base is configured to fit into the upper part of a cell for receiving a nuclear fuel assembly.

30. The intervention device according to claim 16, further comprising several interchangeable intervention tools.
